(19) United States
(12) Patent Application Publication
(10) Pub. No.: US 2012/0072872 A1
(43) Pub. Date: Mar. 22, 2012

(54) METHODS AND SYSTEMS FOR OPTIMIZATION OF HIERARCHY SCREEN REFRESHES

(75) Inventors: Christian Mahr, Pilgerstadt (DE); Daniel Waasmaier, Neugasse (DE); Lukas Hoffmann, Schwetzinger Strasse (DE)

(73) Assignee: SAP AG

(21) Appl. No.: 12/887,162

(22) Filed: Sep. 21, 2010

(51) Int. Cl. G06F 3/048

(52) U.S. Cl. 715/854

(57) ABSTRACT

Systems and methods consistent with certain embodiments of the invention relate to optimization of hierarchy screen refreshes in a graphical user interface. According to one exemplary embodiment, a method for refreshing a graphical user interface that includes a navigation hierarchy is disclosed. The method comprises storing a first representation of the navigation hierarchy at a front end system and a second representation of the navigation hierarchy at a back end system, the second representation being a reduced version of the first representation. The method receives a user interaction with the graphical user interface and sends user inputs to the back end system if the user interaction triggers an event. The method determines at the back end system an updated representation of the navigation hierarchy based on the user inputs, without requesting the first representation of the navigation hierarchy from the front end system. The method also sends to the front end system difference information describing a difference between the updated representation and the second representation; and refreshes the graphical user interface based on the difference information.

### TECHNICAL FIELD

The present invention relates to methods and systems for front-end and back-end optimization of hierarchy screen refreshes. More particularly, the invention relates to methods and systems for optimizing hierarchy screen refreshes by reducing roundtrips between the front end and the back end.

### BACKGROUND

Enterprises and organizations of all sizes often rely on software applications to conduct business. Business software applications, such as SAP industry solutions, often include one or more Graphical User Interfaces (GUIs) that allow user interactions with the applications. A GUI often includes two types of screen areas: a hierarchy (also known as “tree”) for navigation, and a data-capturing view for receiving data inputs and displaying data.

User interactions with either of the screen areas, such as navigation inputs to the tree and data inputs to the data-capturing view, may be collected by the interface layer of the software, known as the “front end.” If a user interaction triggers an event, the user inputs may be sent to the processing layer of the software, known as the “back end.” For example, a user interaction to expand a node of a navigation tree may trigger an event at the back end. The back end may then process the user inputs and refresh both of the screen areas. As another example, a user interaction to collapse a node of a navigation tree may change the appearance of the navigation tree, but does not trigger an event that requires back end processing.

Typically, a full representation of the navigation tree may be stored at both the front end and the back end. Since every user interaction is captured by the front end, the tree representation at the front end is most current. However, since not all the user interactions trigger an event at the back end, the tree representation at the back end may not always be synchronized with the one at the front end. Therefore, in order to provide data to refresh the screen areas, the back end has to request the most current tree representation from the front end. As a result, a roundtrip communication between the front end and the back end is required for every dialog step. Such roundtrips may impact the performance of the software system.

Accordingly, there exists a need to optimize the hierarchy screen refreshes by reducing roundtrips between the front end and the back end.

### SUMMARY

Systems and methods consistent with certain embodiments of the invention relate to optimization of hierarchy screen refreshes in a graphical user interface. According to one exemplary embodiment, a method for refreshing a graphical user interface that includes a navigation hierarchy is disclosed. The method comprises storing a first representation of the navigation hierarchy at a front end system and a second representation of the navigation hierarchy at a back end system, the second representation being a reduced version of the first representation. The method receives a user interaction with the graphical user interface and sends user inputs to the back end system if the user interaction triggers an event. The method determines at the back end system an updated representation of the navigation hierarchy based on the user inputs, without requesting the first representation of the navigation hierarchy from the front end system. The method also sends to the front end system difference information describing a difference between the updated representation and the second representation; and refreshes the graphical user interface based on the difference information.

It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute a part of this specification, illustrate several embodiments consistent with the invention and together with the description, serve to explain the principles of the embodiments. In the drawings:

FIG. 1 illustrates an exemplary GUI, consistent with an embodiment of the invention;

FIG. 2 illustrates an exemplary system for refreshing a GUI, consistent with an embodiment of the present invention;

FIG. 3A illustrates an exemplary representation of a navigation hierarchy at a front end system, consistent with an embodiment of the present invention;

FIG. 3B illustrates an exemplary representation of a navigation hierarchy at a back end system, consistent with an embodiment of the present invention;

FIG. 4 is an exemplary flow chart for refreshing a GUI upon a user interaction with the GUI, consistent with the present invention;

FIG. 5 illustrates an exemplary event loop for refreshing a GUI, consistent with the embodiment of FIG. 4;

FIG. 6 is an exemplary flow chart for refreshing a GUI upon a user interaction involving a full representation of a navigation hierarchy, consistent with the present invention; and

FIG. 7 illustrates an exemplary event loop for refreshing a GUI, consistent with the embodiment of FIG. 6.

### DESCRIPTION OF THE EMBODIMENTS

The following description refers to the accompanying drawings. Wherever possible, the same reference numbers will be used throughout the drawings to refer to the same or similar parts. While several exemplary embodiments and features are described herein, modifications, adaptations and other implementations are possible, without departing from the spirit and scope of the invention. For example, substitutions, additions or modifications may be made to the components illustrated in the drawings, and the exemplary methods described herein may be modified by substituting, reordering, or adding steps to the disclosed methods. Accordingly, the following detailed description does not limit the invention. Instead, the proper scope of the invention is defined by the appended claims.

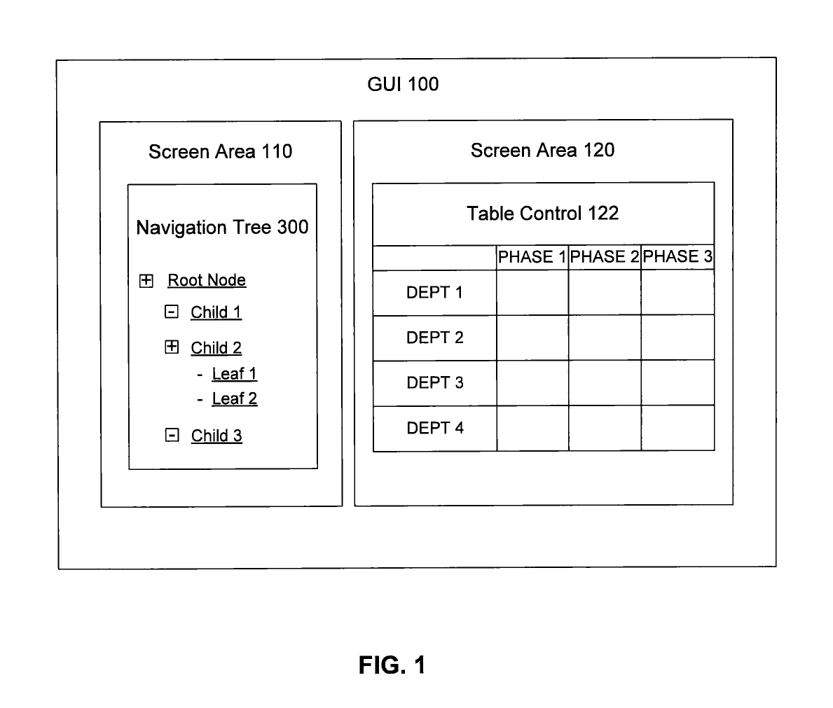

FIG. 1 illustrates an exemplary GUI 100. As shown in FIG. 1, GUI 100 of a business software application may include two screen areas: screen area 110 and screen area 120. It is contemplated that GUI 100 may include less or more screen areas to facilitate user interactions. It is also contemplated that GUI 100 may include screen areas of other formats and/or other functionalities.

Screen area 110 may include a hierarchy for navigation, such as navigation tree 300 shown in FIG. 1. Navigation tree 300 may include one or more root nodes and a root node may have one or more child nodes. A child node may further have its own child nodes. Nodes that are at the same level of the tree and share a same parent node are known as sibling nodes. In some embodiments, representation of a node may be expanded by a user, for example, by double clicking on the node. When a node is expanded, its child nodes may be visible to the user and a “−” symbol may show in front of the node. In some embodiments, an expanded node may also be collapsed by the user, for example, by a click on the “−” symbol in front of the node or single click on the node. When a node is collapsed, its child nodes may be hidden and made invisible to the user. The “−” symbol shown in front of the node may be replaced with a “+” symbol. Consistent with some embodiments, nodes may also be added to navigation tree 300 or deleted from navigation tree 300.

Screen area 120 may include a data-capturing view that allows user data inputs or edits. For example, screen area 120 may include a table control 122. As shown in FIG. 1, table control 122 may show include columns and rows that form multiple cells. A user may enter data into a cell, or select one or more cells. In some embodiments, table control 122 may include column and row headers that the user may use to select entire columns or rows. Table control 122 may also include an inbuilt scroll mechanism that allows the user to scroll down and scroll to the right of the table. The user may also add or remove a column or a row from table control 122, or change the width of columns or rows and/or rearrange their order.

Table control 122 may be controlled either automatically by the business software application, or manually by the user. In some embodiments, table control 122 may be dynamically modified by the business software application, for example, columns can be hidden. When table control 122 is dynamically modified, user control may be switched off to avoid unforeseen problems.

User interactions with GUI 100, such as navigation inputs to navigation tree 300 and data inputs to table control 122, require screen refreshes to GUI 100. For example, when a node of navigation tree 300 is double clicked, screen area 110 may be updated to expand the node and show its child nodes. Accordingly, screen area 120 may also be updated to display information consistent to the node expansion.

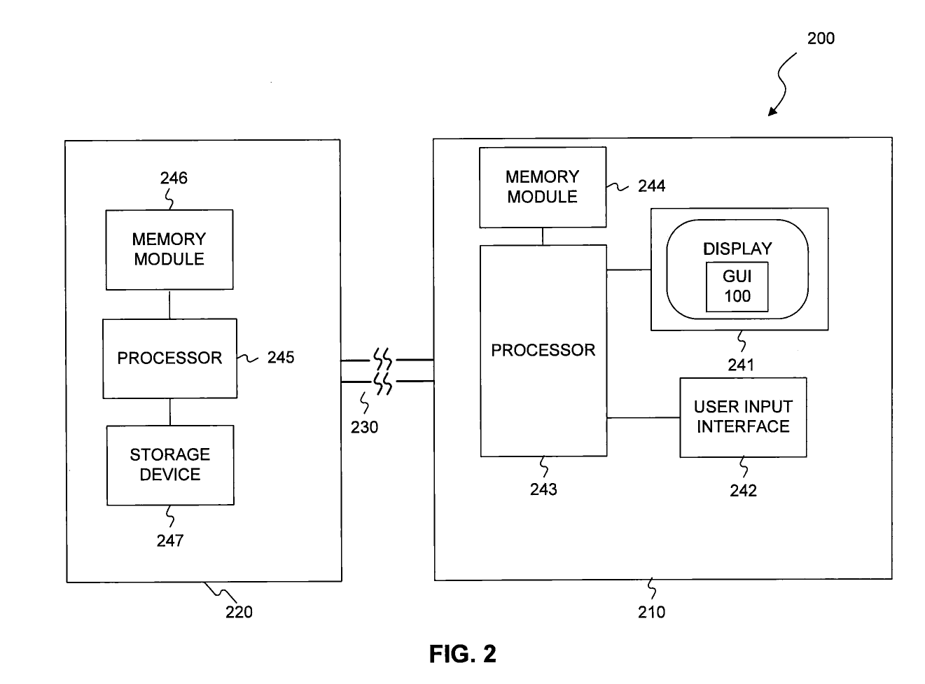

FIG. 2 illustrates an exemplary system 200 for refreshing a GUI. As shown in FIG. 2, system 200 may include a front end system 210 and a back end system 220. In some embodiments, front end system 210 and back end system 220 may be located on the same computer, such as an application server. In some other embodiments, front end system 210 and back end system 220 may be located on different computers, being connected by a communication network 230, such as an Ethernet, Wireless LAN or other appropriate network. For example, front end system 210 may be located on a client terminal and back end system 220 may be located on a central server.

Front end system 210 and back end system 220 may implement various types of software application. For instance, systems 210 and 220 may include software applications such as native Windows™ applications, JAVA™-based applications, and/or database management systems. Software applications on systems 210 and 220 may also comprise operating systems for common computer systems as well as operating systems for software-controlled devices, such as industrial robots. Further, systems 210 and 220 may include an entire software application or only a part of a software application. A software application or a part of a software application may be referred to as a “software object.” A software object may also contain master data, user data, application data and/or program code.

As shown in FIG. 2, front end system 210 may include a display device 241, a user input interface 242, a processor 243, and a memory module 244. For example, display device 241 can include a computer screen which displays GUI 100 to the user. User input interface 242 can be provided for the user to input information into data processing system 140, and can include, for example, a keyboard, a mouse, and/or optical or wireless computer input devices (not shown). The user can interact with GUI 100 via user input interface 242. For example, the user can move the mouse and click on certain nodes of navigation tree 300 or push certain buttons on a keyboard to input data to table control 122.

Processor 243 can be a central processing unit (“CPU”) or a graphic processing unit (“GPU”). Depending on the type of hardware configuration being used on the client terminal, processor 243 can include one or more microprocessor chips. Processor 243 can execute sequences of computer program instructions to perform various methods that will be explained in greater detail below. Memory module 244 can include, among other things, a random access memory (“RAM”) and a read-only memory (“ROM”). The computer program instructions can be accessed and read from the ROM, or any other suitable memory location, and loaded into the RAM for execution by processor 243. For example, memory module 244 may store one or more front end software applications.

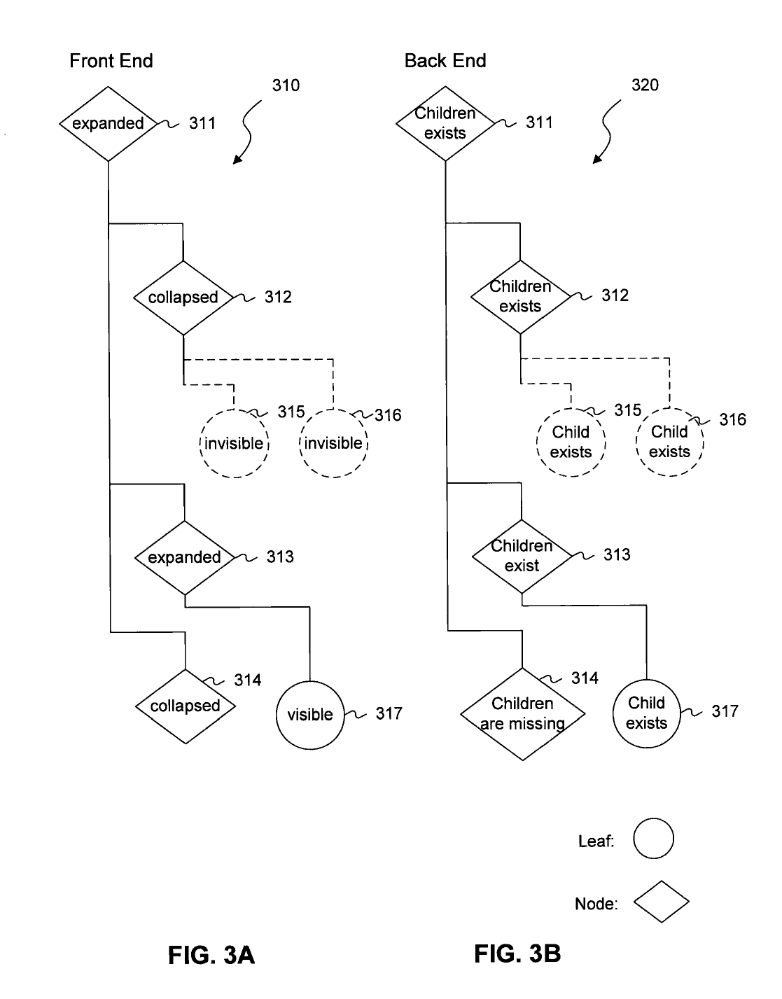

In some embodiments, memory module 244 may further store a front end representation of the navigation hierarchy, such as a navigation tree displayed in the GUI. FIG. 3A illustrates an exemplary front end representation 310 of a navigation hierarchy stored at front end system 210. As shown in FIG. 3A, the exemplary navigation tree has a root node 311, which has three child nodes 312-314. Root node 311 is expanded, so all three child nodes 312-314 are visible to the user. Node 312 is collapsed and further has two children: leaf node 315 and leaf node 316, both of which are invisible to the user. Leaf nodes 315 and 316 do not have any further child nodes and thus, are not further expandable. Node 313 is expanded and has one visible child node: leaf node 317, which has no further child nodes. Node 314 is collapsed and has one or more missing children, which are currently unknown but can be determined on demand. Consistent hereafter, both “leaf nodes,” such as 315 and 316, and “non-leaf nodes,” such as 311-312, are both referred to as “nodes” in this specification.

Consistent with some embodiments, front end representation 310 may be a full representation of the navigation tree. That is, front end representation 310 may include all the information that is necessary for building the navigation tree. For example, front end representation 310 may store data describing nodes 311-317 as well as their status information. In some embodiments, data describing a node may include name of the node, the relative position of the node in the navigation tree, and its relationship with other nodes. For example, front end representation 310 may record that node 311 has three child nodes 312-314, and node 312 has two child nodes 315 and 316. Front end representation 310 may also record the order of sibling nodes present in the tree. For example, nodes 312-314 may be recorded as the first child node, the second child node, and the third child node of node 311. In some embodiments, data describing a node, such as node 314, may further include that the node has a missing child node.

Consistent with some embodiments, the status information of a node may include an identification whether it is collapsed or expanded. For example, front end representation 310 may record that nodes 311 and 313 are expanded, and nodes 312 and 314 are collapsed. The status information of a leaf node may further include an indicator whether it is visible to the user. For example, front end representation 310 may record that nodes 315 and 316 are invisible, and node 317 is visible.

As shown in FIG. 2, back end system 220 may include a processor 245, a memory module 246, and a storage device 247. Similar to processor 243, processor 245 may also be a central processing unit (“CPU”) or a graphic processing unit (“GPU”), and may be configured to execute sequences of computer program instructions to perform various processes. Memory module 246 can include, among other things, a random access memory (“RAM”) and a read-only memory (“ROM”), which store various back end software applications for execution.

In some embodiments, memory module 246 may further store a back end representation of the navigation hierarchy, such as navigation tree 300, displayed in the GUI. FIG. 3B illustrates an exemplary representation 320 of the same navigation hierarchy as in FIG. 3A, stored at back end system 220. As shown in FIG. 3B, unlike front end representation 310, back end representation 320 may be a reduced representation of the navigation tree. That is, back end representation 320 may not include all the information that is necessary for building the navigation tree. Instead, back end representation 320 may only include part of the information that is included in front end representation 310.

In some embodiments, back end representation 320 may only include information identifying which nodes exist in the navigation tree and the relationship among the existing nodes. For example, with respect to root node 311, back end representation 320 may only indicate that it exists and has three child nodes 312-314. Back end representation 320 may also include the relative order of the three child nodes 312-314 present in the tree, for example, node 312 being the first child node, node 313 being the second child node, and node 314 being the third child node. With respect to node 312, back end representation 320 may further indicate that node 312 also exists and has a first child node 315 and a second child node 316, both of which exist. With respect to node 314, back end representation 320 may indicate that node 314 exists but the child nodes are missing. In some embodiments, back end representation 320 may completely drop the status information that is included in front end representation 310. For example, in back end representation 320, there may be no identification whether a node is expanded or collapsed, visible or invisible to the user.

Being a reduced representation of the navigation tree, back end representation 320 does not have to be updated upon each user interaction. For example, expanding or collapsing a node does not change the existence of nodes, but rather, only their statuses. Therefore, back end representation 320 may be updated only if a node is added or deleted from the navigation tree.

In some embodiments, back end system 220 may further include a storage device 247. Storage device 247 can include any type of mass storage suitable for storing information. For example, storage device 247 can include one or more hard disk devices, optical disk devices, or any other storage devices that provide data storage space. In one embodiment of the present disclosure, storage device 247 can store user input data collected by and transmitted from front end system 210, and any intermediate data created during data processing processes executed by processor 245. For example, storage device may store data input into cells of table control 122, and/or data generated by processor 245 to refresh GUI 100. In some embodiments, storage device 247 may further store a database that contains data of a business partner. Storage device 247 can also include analysis and organization tools for analyzing and organizing the information contained therein.

Both front end system 210 and back end system 220 can include additional, fewer, and/or different components than those listed above. The type and number of listed devices are exemplary only and not intended to be limiting. In some embodiments, for example, when front end system 210 and back end system 220 are located on the same computer, they may share the same processor and memory module. That is, processor 243 and memory module 244 may be integrated with processor 245 and memory module 246. In some other embodiments, for example, when front end system 210 and back end system 220 are located at different sites, back end system 220 may have a separate pair of processor and memory module from that of front end system 210, as shown in FIG. 2.

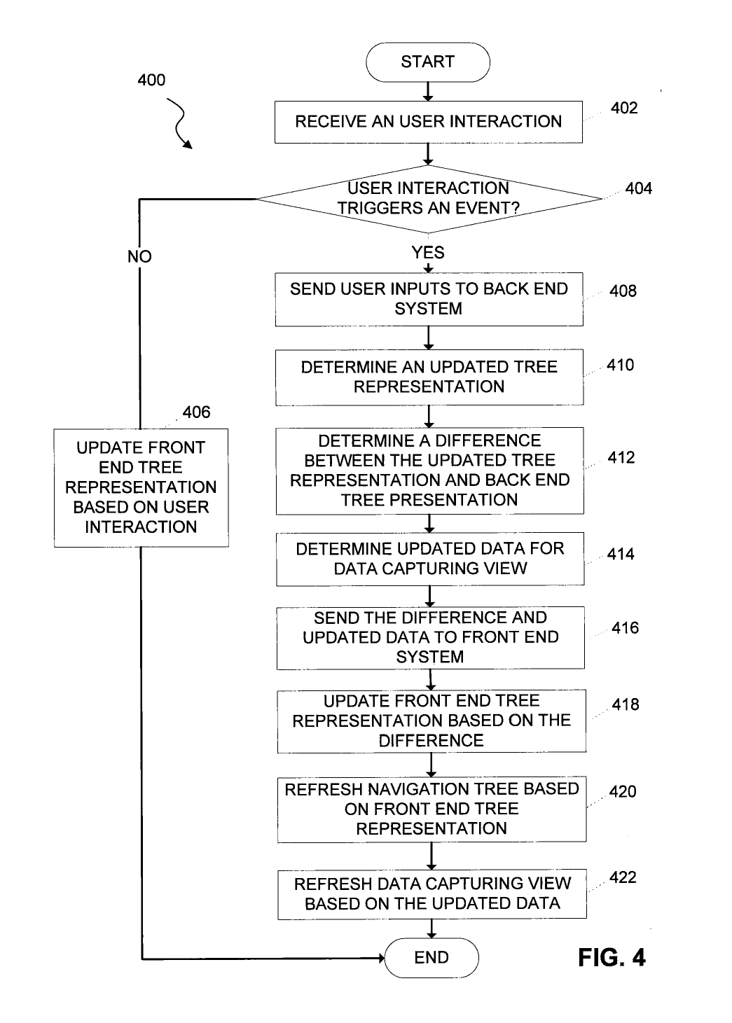

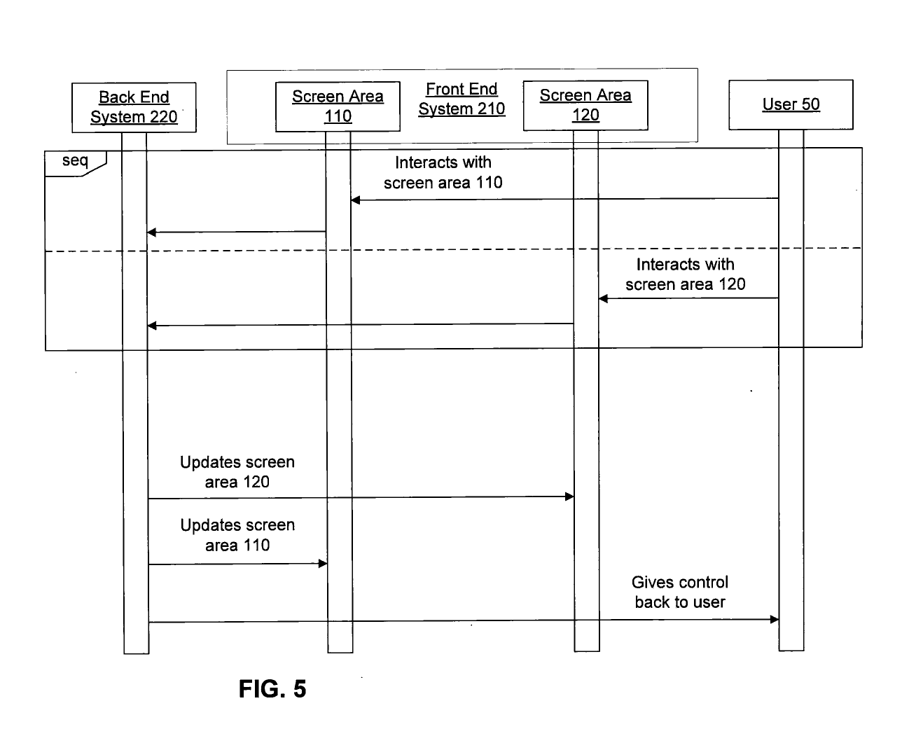

One or more components of system 200 may be used to implement a process for refreshing GUI 100 upon a user interaction. FIG. 4 is an exemplary flow chart for a method 400. FIG. 5 illustrates an exemplary event loop for refreshing a GUI, consistent with the embodiment of FIG. 4. Process 400 may begin when a user interaction with a GUI is received at the front end system (step 402). In some embodiments, as shown in FIG. 5, user 50 may interact with screen area 110 (FIG. 1) and/or screen area 120 as part of GUI 100 on display device 241. For example, user 50 may double click on a node of navigation tree 300 to expand or collapse the node, add or delete a node from navigation tree 300, or highlight a node. Additionally or alternatively, user 50 may also enter a name or add a line to table control 122. In some embodiments, user inputs, such as the data input to data-capturing view in screen area 120, may be received along with or as part of the user interaction.

A processor may determine if the user interaction triggers an event that requires back end processing (step 404). Some user interactions with the navigation tree may trigger an event, while some others may not. For example, expanding a node triggers an event, while collapsing a node does not. Adding or deleting a node may also trigger an event. Rearranging the relationship between a node and its children may trigger an event, while rearranging the order of a node relative to its sibling nodes may not. In addition, interactions with the data-capturing view, such as entering or deleting data, usually trigger an event.

If it is determined that an event is not triggered (step 404: no), process 400 may be directed to update the front end tree representation based on the user interaction (step 406). For example, if the user merely collapses a node, front end representation 310 may be updated such that the status of the node is changed to collapsed and statutes of its child nodes are changed to invisible. When an event is not triggered, the back end tree representation is not updated.

If it is determined that an event is triggered (step 404: yes), system 200 may take control from the user, and process 400 may be directed to send the received user inputs to the back end system (step 408). For example, as shown in FIG. 5, user inputs from screen area 110 are sent to back end system 220. The user inputs may be processed by the back end system, where an updated tree representation is determined (step 410). For example, if a node of navigation tree 300 is expanded and the node has three child nodes, the updated tree representation may be adjusted to reflect this change. In some embodiments, if a node is added to navigation tree 300, the updated tree representation may be adjusted to include the new node. In some embodiments, adding a node relative to sibling nodes may be implemented by a method that moves nodes according to a “last-child” relationship. The order of the sibling nodes may then be adjusted. For example, the new node may be added as a last child node, and then the siblings that have the wrong positions in the navigation tree may be moved to the end.

The updated tree representation obtained from step 410 may be compared to the back end tree representation, and a difference between the two may be determined (step 412). For example, the difference may include additional information in the updated tree representation that is missing in the back end tree representation. Process 400 may further determine updated data for the data-capturing view in screen area 120 based on the user inputs (step 414). For example, the processor at the back end system may execute certain business logic and loading data of a business partner from a database in storage device 247.

With the back end tree representation being a reduced representation, as described above in connection with FIG. 3B, neither step 410 nor step 414 requires acquiring the full tree representation from the front end system. That is because processing user inputs at the back end system only needs information as of which nodes exist at the front end as well as the order of sibling nodes in the tree, and this information can be provided by the back end tree representation without synchronizing with the front end tree representation.

The difference in tree representation and the updated data may be sent to the front end system (step 416). For example, as shown in FIG. 5, the difference in tree representation may be sent to screen area 110 and the updated data may be sent to screen area 120. The front end tree representation may be updated based on the difference sent in step 416 (step 418). For example, the status of a node may be changed from “collapsed” to “expanded,” and the statuses of its child nodes may be changed from “invisible” to “visible.” The navigation tree in screen area 110 may then be updated according to the front end tree representation (step 420). The data-capturing view in screen area 120 may also be updated according to the updated data provided by the back end system (step 422). Once GUI 100 is updated, system 200 may give the control back to user 50, and process 400 may terminate.

While GUI screen refreshes associated with most of the user interactions may be processed using process 400 described above, certain user actions with the navigation tree may require additional processing steps. For example, the user may save navigation tree 300 exactly as it appears in screen area 110, or request to print the tree. Processing such user interactions may require more information than merely the existence of the nodes and the order of sibling nodes. Sometimes, it may require information of the full tree as dictated in the front end tree representation.

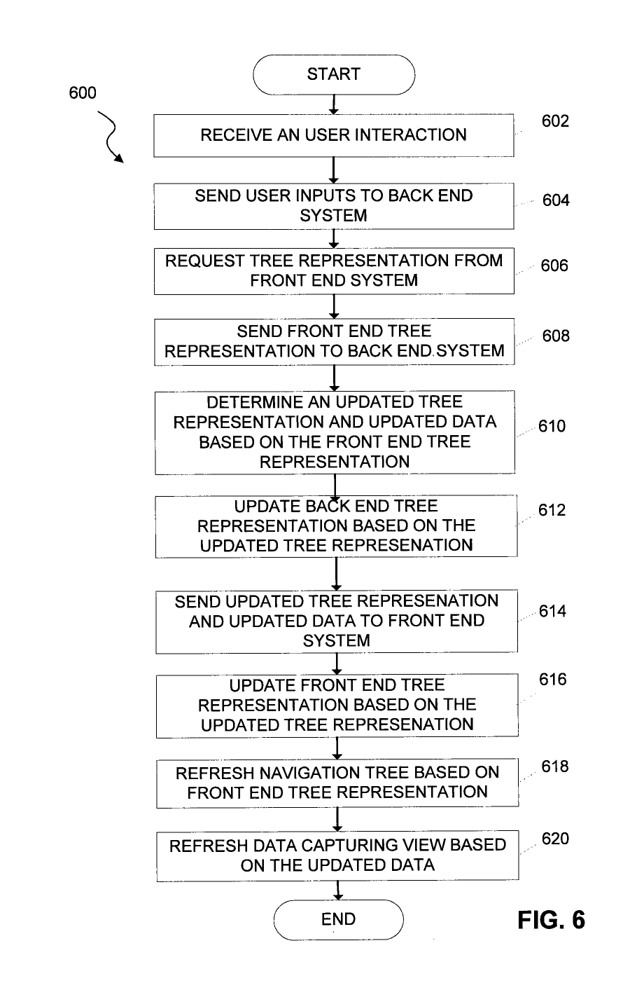

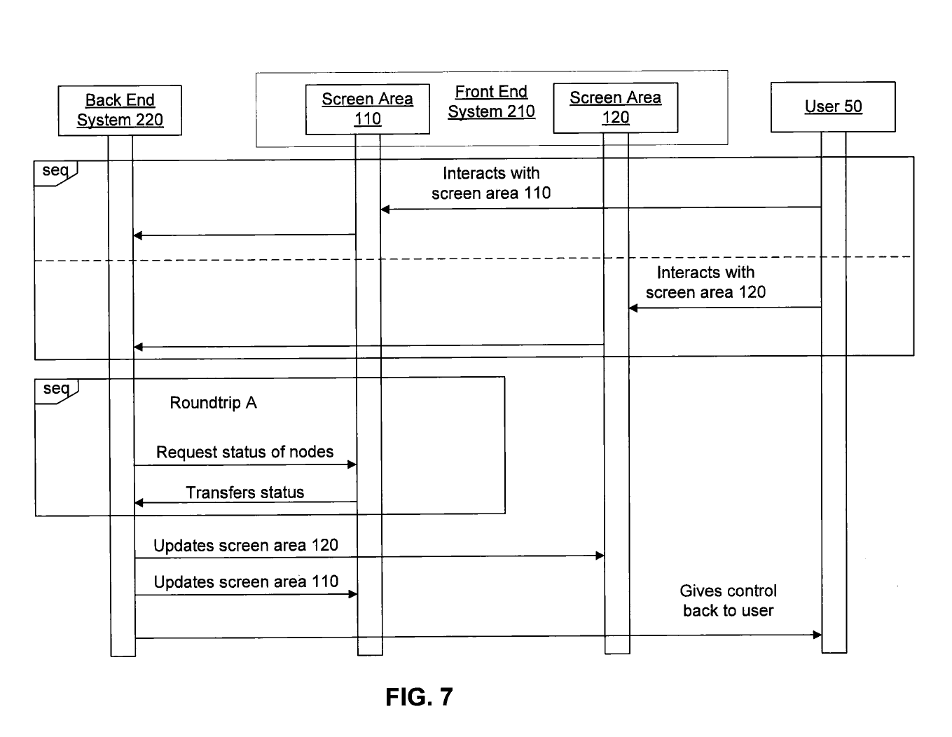

FIG. 6 is an exemplary flow chart for a process 600 implemented by system 200 upon a user interaction that changes the structure of the navigation hierarchy. FIG. 7 illustrates an exemplary event loop for refreshing a GUI, consistent with the embodiment of FIG. 6. Process 600 may begin when a user interaction with a GUI is received at the front end system (step 602). Process 600 may include sending the received user inputs to the back end system (step 604). As shown in FIG. 5, in order to process the user inputs, back end system 220 may request a full representation of the tree from front end system 210 (step 606). For example, printing the tree may require information regarding all the nodes and their statuses, which are not included in the back end tree representation but are included in the front end tree representation. The requested front end tree representation may be sent from front end system 210 to back end system 220 (step 608).

With the requested information from the front end system, the user inputs may be processed by the back end system (step 610). As in step 414 of FIG. 4, the processor at the back end system may execute certain business logic and load data of a business partner from a database in storage device 247.

The back end tree representation may be updated based on the updated tree representation (step 612). In some embodiments, the updated tree representation may be reduced to an updated second representation. For example, excessive information such as status information of the nodes may be removed from the updated tree representation.

As shown in FIG. 7, the updated tree representation and updated data may be sent to the front end system (step 614). In some embodiments, step 612 may also be implemented such that only the difference between the updated tree representation and the back end tree representation, instead of the entire updated tree representation, is sent to the front end system, as described in step 412 of FIG. 4. The front end tree representation may be updated based on the updated tree representation (step 616), and the navigation tree in screen area 110 may be updated according to the front end tree representation (step 618). The data-capturing view in screen area 120 may also be updated according to the updated data provided by the back end system (step 620). Once all the screen areas of GUI 100 is refreshed, system 200 may give the control back to user 50, and process 600 may terminate.

For purposes of explanation only, certain aspects and embodiments are described herein with reference to the components illustrated in FIGS. 1-7. The functionality of the illustrated components may overlap, however, and may be present in a fewer or greater number of elements and components. Further, all or part of the functionality of the illustrated elements may co-exist or be distributed among several geographically dispersed locations. Moreover, embodiments, features, aspects and principles of the present invention may be implemented in various environments and are not limited to the illustrated environments.

Further, the sequences of events described in FIGS. 1-7 are exemplary and not intended to be limiting. Thus, other method steps may be used, and even with the methods depicted in FIGS. 1-7, the particular order of events may vary without departing from the scope of the present invention. Moreover, certain steps may not be present and additional steps may be implemented in FIGS. 1-7. Also, the processes described herein are not inherently related to any particular apparatus and may be implemented by any suitable combination of components.

Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. A computer-implemented method for refreshing a graphical user interface that includes a navigation hierarchy, comprising:
storing a first representation of the navigation hierarchy at a front end system and
a second representation of the navigation hierarchy at a back end system,
the second representation being a reduced version of the first representation;
receiving a user interaction with the graphical user interface;
sending user inputs to the back end system if the user interaction triggers an event;
determining at the back end system, by a processor, an updated representation of the navigation hierarchy based on the user inputs, without requesting the first representation of the navigation hierarchy from the front end system;
sending to the front end system, by the processor, difference information describing a difference between the updated representation and the second representation; and
refreshing the graphical user interface based on the difference information.

2. The method of claim 1, wherein the graphical user interface further includes a data-capturing view, and wherein the method further comprises:
determining at the back end system, by the processor, updated data for the data-capturing view based on the user inputs; and refreshing the data-capturing view based on the updated data.

3. The method of claim 1, wherein refreshing the graphical user interface comprises:
updating the first representation based on the difference information; and
refreshing the graphical user interface according to the first representation.

4. The method of claim 1, further comprising updating the first representation based on the user inputs if the user interaction does not trigger an event, without updating the second representation at the back end system.

5. The method of claim 1, wherein the user interaction expands or collapses a node of the navigation hierarchy.

6. The method of claim 1, wherein the user interaction adds a node to or deletes a node from the navigation hierarchy.

7. The method of claim 2, wherein the user interaction enters data to the data-capturing view.

8. The method of claim 1, wherein the first representation of the navigation hierarchy includes data describing a plurality of nodes of the navigation hierarchy and status information of the plurality of nodes.

9. The method of claim 8, wherein the status information of a node includes an indication of whether the node is expanded or collapsed.

10. The method of claim 8, wherein the first representation further includes data describing one or more child nodes of a node and status information of the one or more child nodes, wherein the status information of a child node indicates whether the child node is visible or invisible to a user.

11. The method of claim 8, wherein the data describing a node includes an indicator that the node has one or more child nodes that are missing.

12. The method of claim 8, wherein the second representation includes reduced information compared to the first representation, wherein the reduced information includes indications that the plurality of nodes exist.

13. The method of claim 8, wherein the plurality of nodes include a plurality of sibling nodes, and the reduced information includes an order of the sibling nodes in the navigation hierarchy.

14. The method of claim 1, further comprising updating, by the processor, the second representation if the user interaction adds a node to the navigation hierarchy, wherein updating the second representation includes adding the node as a last child among sibling nodes.

15. A system for refreshing a graphical user interface that includes a navigation hierarchy, comprising:
a front end system having a first representation of the navigation hierarchy stored thereon, wherein the front end system is configured to:
receive a user interaction with the graphical user interface; and
send user inputs to the back end system if the user interaction triggers an event; and
a back end system having a second representation of the navigation hierarchy stored thereon, the second representation being a reduced version of the first representation, wherein the back end system comprises a processor configured to:
determine at the back end system an updated representation of the navigation hierarchy based on the user inputs, without requesting the first representation of the navigation hierarchy from the front end system;
send to the front end system difference information describing a difference between the updated representation and the second representation; and
refresh the graphical user interface based on the difference information.

16. The system of claim 15, wherein the graphical user interface further includes a data-capturing view, and wherein the processor is further configured to:
determine updated data for the data-capturing view based on the user inputs at the back end system; and
refresh the data-capturing view based on the updated data.

17. The system of claim 15, wherein the processor is further configured to update the first representation based on the user inputs if the user interaction does not trigger an event, without updating the second representation at the back end system.

18. The system of claim 15, wherein the first representation includes data describing a plurality of nodes of the navigation hierarchy and status information of the plurality of nodes.

19. The system of claim 18, wherein the second representation includes reduced information compared to the first representation, wherein the reduced information includes identifications that the plurality of nodes exist, wherein the plurality of nodes include a plurality of sibling nodes, and the reduced information includes an order of the sibling nodes in the navigation hierarchy.

20. The system of claim 15, wherein the processor is further configured to update the second representation if the user interaction adds a node to the navigation hierarchy, wherein updating the second representation includes adding the node as a last child among sibling nodes.
